(19) United States
(12) Patent Application Publication
(10) Pub. No.: US 2010/0017670 A1
(43) Pub. Date: Jan. 21, 2010

(54) Automatic Data Recovery System

(75) Inventors: Jacob Jason Rosales, Austin, TX (US); Jorge D. Rodriguez, Austin, TX (US); Jorge A. Rasillo, Austin, TX (US); Rene Ruben Martinez, Cedar Park, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(73) Assignee: International Business Machines Corporation, Armonk, TX (US)

(21) Appl. No.: 12/176,587

(22) Filed: Jul. 21, 2008

(51) Int. Cl. G06F 11/14

(52) U.S. Cl. 714/747; 714/E11.113

(57) ABSTRACT

A method, programmed medium and system are provided for recovering media-stored program code and/or user data when data on the same media are lost or corrupted. The system includes retrieving user data and/or program code from an external source when the actual data/code is not readable. When initiating the load of local storage, an initial scan for damaged regions is performed. If the initial scan determines that there are damaged/bad regions, the media player will look for the necessary data and/or code to patch the digital media. In one embodiment, a hardware or software look-ahead reader function, for example, is enabled to retrieve the original undamaged data/code from the local storage when an attempt to read a region from an optical disk fails due to a bad region. If the region in question is not stored locally, then a request is automatically transmitted to the original data provider to re-send the original data/code, which may include original program code. The data provider will then respond by sending the missing data/code to the user system where it will, in turn, be stored within the local storage device for further access and use.

### FIELD OF THE INVENTION

The present invention relates generally to information processing systems and more particularly to a methodology and implementation for enabling an automatic recovery of user data and/or program code.

### BACKGROUND OF THE INVENTION

Digital storage media are easily damaged if owners are not careful in the handling of the material and/or because of hardware failures. Once a storage medium, for example an optical disc, becomes scratched or damaged, portions of the disc may become unreadable by the system. This, in turn, may result in an inability to read and play data from the damaged storage medium.

In order to prevent the loss of data and/or poor playback, owners must resort to making backup copies of the code and/or data stored on the medium and revert to the copies if needed. This requires the use of extra media and software that is able to write the data/code to the media. This process is time consuming and many times backup copies are not made. As a result, in many cases, damaged media results in a permanent loss of user data.

Thus, there is a need to provide a data retrieval system which is effective to restore data that is lost or rendered unreadable.

### SUMMARY OF THE INVENTION

A method, programmed medium and system are provided for recovering media-stored program code and/or user data when data on the same media are lost or corrupted. The system includes retrieving user data and/or program code from an external source when the actual data/code is not readable. When initiating the load of local storage, an initial scan for damaged regions is performed. If the initial scan determines that there are damaged/bad regions, the media player will look for the necessary data and/or code to patch the digital media. In one embodiment, a hardware or software look-ahead reader function, for example, is enabled to retrieve the original undamaged data/code from the local storage when an attempt to read a region from an optical disk fails due to a bad region. If the region in question is not stored locally, then a request is automatically transmitted to the original data provider to re-send the original data/code, which may include original program code. The data provider will then respond by sending the missing data/code to the user system where it will, in turn, be stored within the local storage device for further access and use.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is a block diagram showing several of the major components of an exemplary system terminal implementation using the present invention; and

FIG. 3 is a flow chart illustrating an exemplary sequence of operations which may be implemented in accordance with the present invention.

### DETAILED DESCRIPTION

The various methods discussed herein may be implemented within a computer system which includes processing means, memory, updateable storage, input means and display means. Since the individual components of a computer system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although the invention is illustrated in the context of a networked computer system, it is understood that disclosed methodology may also be applied in many other available and future devices and systems to achieve the beneficial functional features described herein.

In an exemplary implementation, when a user downloads application program code from a server over an interconnection network such as the Internet, the code is processed for execution on the user system and stored on local storage, for example a hard drive, within the user's system. Alternatively, the initial load to the user system may be accomplished from another medium such as an optical disc or portable flash memory device. After storage, the user is enabled to retrieve the application from local hard drive or flash storage and run the application on the user system. Further, in many applications, the user is enabled to input user data which is stored with the application for subsequent access by the user.

In the present example, if the original optical disc medium or flash memory device is damaged, when the user tries to load the application and data into user memory for execution, the application will not execute and the user will be unable to run the application. In accordance with the present invention, when the user initializes an application from a storage medium, the medium is first scanned for readable data. This function may be implemented in hardware or software. In the present example, a look-ahead hardware device is used. If the initial scan detects that one or more regions of the medium contain unreadable or defective data, the system calls for replacement code first from local storage and if the code or data is not available form local storage, then the system will determine a server source for the original code or other location where backup data may be stored, and automatically request replacement code either for only for the damaged regions or for the entire medium content. This replacement function is carried out in the background, and, depending upon the speed of the system, may be totally transparent to the user. In other words, the defective code or data may be detected and replacement code may be automatically requested and loaded to the user system without the user ever knowing that the code replacement operation has occurred. This function would be very useful, for example, when a user loads a digital video disc to watch a movie and the disc contains defective or unreadable code. Instead of being unable to view the DVD and having an error message displayed, the user, after the automatic scanning and detection of the defective regions and the automatic replacement of the code and data, will be able to play the movie without interruption and without any user intervention. In the preferred embodiment, only unreadable regions are replaced rather than the entire media. This methodology enables increased digital data management by only maintaining the minimal amount of data, instead of backing up the entire media, and allows for the use of external third parties to provide and verify the authenticity of the media to provide the missing data. An alternative to this process would be to allow the owner to skip the need to back up the data, and have method or apparatus to determine what data is within the damaged region thus allowing the data to be read in its entirety by the hardware.

In another example, when a user is playing a DVD movie that contains scratches on the disk, when an attempt to read from the damaged area fails, an attempt is automatically made to retrieve the unreadable portion to allow the DVD to remain playing with no interrupts or quality degradation. The medium may also be initially scanned for defective or damaged regions when the medium is initially loaded into the user's system so that the replacement, if necessary can be accomplished ahead of the time when the DVD is to be played.

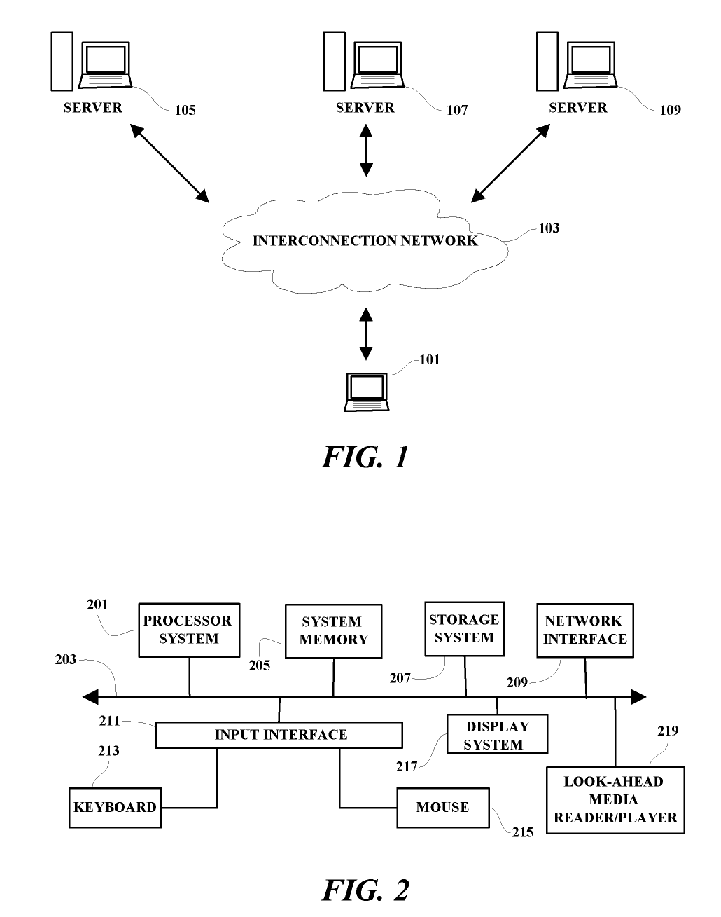

FIG. 1 illustrates an exemplary environment in which the present invention may be implemented. As shown, a user terminal 101, which may be a laptop computer, is connected through an interconnection network 103, such as the Internet, to a plurality of server systems 105, 107 and 109. Each of the server systems 105-109 may be accessed by the user unit 101 to download one or more applications for use at the user terminal 101. The servers 105-109 may also be accessed by the user terminal 101 in order to automatically request a download or reload of application code or data to the user terminal 101 in the event that the user system has determined that one or more regions of a user storage medium containing an application and or related data is defective or has been damaged thereby rendering the code/data unreadable as hereinafter explained in greater detail.

FIG. 2 illustrates several of the major components of a computer system which may be used to implement the present invention. As shown, a processor system 201 is connected to a main bus 203. The main bus 203 is also coupled to, inter alia, system memory 205, a local storage system 207, a network interface 209, an input interface 211 including connections to a keyboard 213 and a mouse or pointing device 215. The main bus is also connected to a display system 217 and a look-ahead reader/player unit 219. The look-ahead reader/player function is configured to initially scan a medium and determine if there are any defective or damaged regions on the medium which result in having at least portions of the medium being unreadable or defective. If unreadable code is detected and replaced, the initial scanning and subsequent playing functions may be performed by the same hardware device or by separate devices, or by a combination of hardware and software depending upon system design criteria.

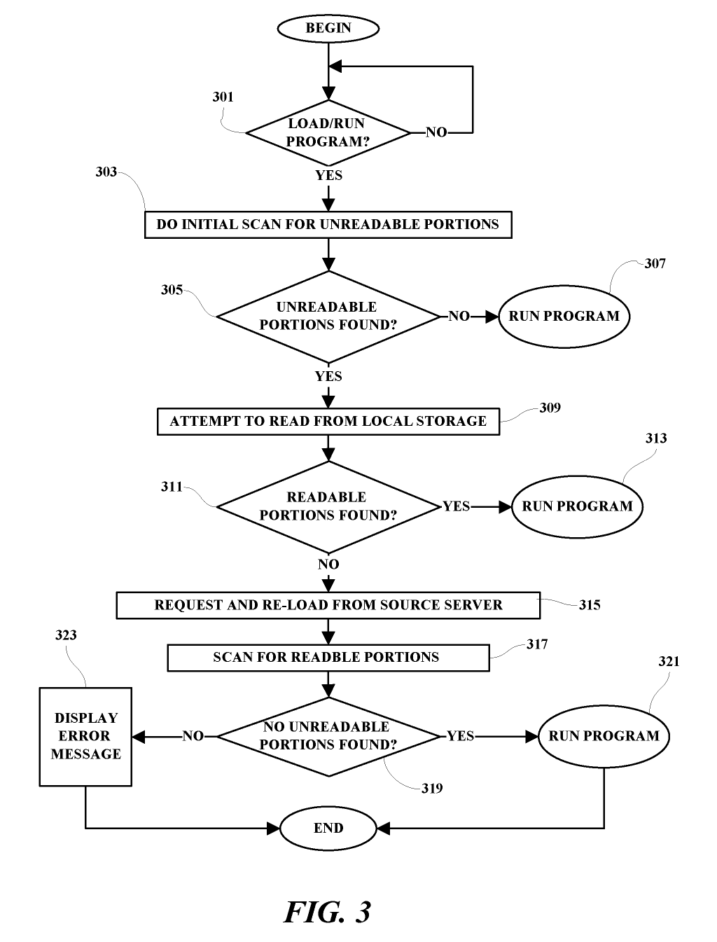

FIG. 3 is a flow chart illustrating an exemplary sequence of operations which may be implemented in accordance with the present invention. As shown, in one example, when a user executes a command to run a program contained in an optical medium or CD 301, an initial scan is performed 303 to scan the medium to determine if any of the code or data is unreadable. If no unreadable portions or regions are found 305, then a medium player will run the program 307 in a normal manner. If, however, unreadable regions are detected 305, then an attempt is made automatically to read and load the readable regions corresponding to the detected unreadable regions from the user's local storage device 309 where a backup copy of the application and/or data may be stored. If readable code or data corresponding to the unreadable code or data on the medium is found in the user's local storage 311, such as the user's hard drive, then the application or file is loaded into memory from the user's local storage and run 313 in a normal manner. This is all accomplished without user intervention or user interfacing of any kind. If readable code or data corresponding to the defective code or data regions on the medium is not found in the user's local storage 311, then the user's system automatically requests and reloads the application and/or data from a source server 315. The source server ID and uniform resource locator (URL) may be identified within the user's CD medium so that the user system will have that address available. Alternatively, if the application was originally downloaded from a source server, the server address will also be available. Further, the request for reload may contain special coding to insure that the reload request is being made by a licensed user because of unreadable code or data in the user application.

After the replacement code and/or data is reloaded to the user system from the source server 315, the downloaded code/data is again scanned for readability 317. If no unreadable regions are detected 319, the application is run in a normal manner 321 without user intervention. If, however, the code and/or data which was downloaded from the source server is found to contain unreadable code/data 319, then an error message may be displayed 323 on the user's display device and the user can then take appropriate action. Alternatively, if unreadable code/data is found on the downloaded code/data from the first source server, additional backup servers may be accessed automatically until readable code/data has been located and downloaded to the user system. In this manner, a user application or file may be played in a seamless manner from a user command to execute the application even though the original medium containing application code and/or data has been damaged and rendered unreadable. Unreadable code/data are replaced automatically, in the background, from a second or additional storage source, without requiring any positive user intervention or program interfacing.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including any portable or fixed, volatile or non-volatile memory media device, including CDs, RAM and “Flash” memory, or other semiconductor, optical, magnetic or other memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for verifying readable code content on a medium, said method comprising:
scanning said medium in response to a predetermined command to determine readability of code contained on said medium; and
accessing a second source for replacement content if it is determined that content on said medium is not readable.

2. The method as set forth in claim 1 wherein said accessing is accomplished automatically without user input.

3. The method as set forth in claim 1 wherein said scanning is accomplished by a look-ahead reader.

4. The method as set forth in claim 3 wherein said medium is a magnetic storage medium.

5. The method as set forth in claim 3 wherein said medium is an optical storage medium.

6. The method as set forth in claim 1 wherein said predetermined command is a command to store said code contained on said medium to a local storage device.

7. The method as set forth in claim 6 wherein said accessing is accomplished automatically prior to said storing of said code contained on said medium on said local storage device.

8. The method as set forth in claim 1 wherein said predetermined command is a command to play said code contained on said medium on a user's player device, said accessing being accomplished automatically prior to said playing of said medium.

9. The method as set forth in claim 1 wherein said second source is a source server connected to said user device through an interconnection network, said source server containing fully readable code content corresponding to said unreadable code contained on said medium, said accessing being accomplished automatically by said user device to said source server.

10. A programmed medium including programming information executable by a computer system for providing program signals for enabling a verification of readability of code content on a player medium, said program signals being effective for enabling the steps of:
scanning said player medium in response to a predetermined command to determine readability of code contained on said player medium; and
accessing a second source for replacement content if it is determined that content on said player medium is not readable.

11. The medium as set forth in claim 1 wherein said accessing is accomplished automatically without user input.

12. The medium as set forth in claim 10 wherein said scanning is accomplished by a look-ahead reader.

13. The medium as set forth in claim 12 wherein said player medium is a magnetic storage medium.

14. The medium as set forth in claim 12 wherein said player medium is an optical storage medium.

15. The medium as set forth in claim 10 wherein said predetermined command is a command to store said code contained on said player medium to a local storage device.

16. The medium as set forth in claim 15 wherein said accessing is accomplished automatically prior to said storing of said code contained on said player medium on said local storage device.

17. The medium as set forth in claim 10 wherein said predetermined command is a command to play said code contained on said player medium on a user's player device, said accessing being accomplished automatically prior to said playing of said player medium.

18. The medium as set forth in claim 10 wherein said second source is a source server connected to said user device through an interconnection network, said source server containing fully readable code content corresponding to said unreadable code contained on said player medium, said accessing being accomplished automatically by said user device to said source server.

19. A system for verifying readable code content on a medium, said method comprising:
scanning means operable for scanning said medium in response to a predetermined command, said scanning being initiated to determine readability of code contained on said medium; and
means for accessing a second source for replacement content if it is determined that content on said medium is not readable.

20. The system as set forth in claim 19 wherein said accessing is accomplished automatically without user input.
